(19) United States
(12) Patent Application Publication
(10) Pub. No.: US 2019/0107142 A1
(43) Pub. Date: Apr. 11, 2019

(54) Nut

(71) Applicant: Neumayer Tekfor Engineering GmbH, Hausach (DE)

(72) Inventors: Thomas ETZOLD, Offenburg (DE); Martin LEHMANN, Hornberg (DE)

(21) Appl. No.: 16/155,361

(22) Filed: Oct. 9, 2018

(30) Foreign Application Priority Data
Oct. 10, 2017 (DE) 10 2017 009 395.4

(51) Int. Cl. F16B 39/284; F16B 33/02

(52) U.S. Cl. CPC F16B 39/284; F16B 33/02

(57) ABSTRACT

A nut with a nut body with several clamping segments at an upper end face of the nut body has an internal thread with at least a first portion and a second portion. The first portion has a first thread pitch that ends at a lower end face of the nut body opposite the upper end face. The second portion has a second thread pitch which is smaller than the first thread pitch. The internal thread may include a third portion having a third thread pitch at least partially located at the clamping segments, where the second portion is between the first and third portions. The third thread pitch may be the same as the first thread pitch.

### CROSS REFERENCE TO RELATED APPLICATIONS

This application claims priority under 35 U.S.C. § 119 from German Patent Application No. 10 2017 009 395.4, filed Oct. 10, 2017, the entire disclosures of which are herein expressly incorporated by reference.

### BACKGROUND AND SUMMARY OF THE INVENTION

The invention relates to a nut with a nut body and several clamping segments emerging from an upper end face of the nut body, wherein the nut comprises an internal thread extending along a longitudinal axis.

A nut of this kind is disclosed in DE 195 32 709 A1. The nut there has an internal thread with constant pitch. A method for the manufacturing of a nut with a variable pitch of the internal thread is described by U.S. Pat. No. 4,956,888. CH 319 333 A discloses a nut with a constantly variable pitch of the internal thread. A nut tapering conically in one direction is disclosed by CH 265609 A. The conically tapering portion here has grooves. Similar clamping tongues are disclosed by DE 100 52 915 B4. A nut with an inner indentation to receive a lubricant is described in U.S. Pat. No. 1,123,505. The benefits for the fastening when the pitch of the internal thread of the nut differs from the pitch of the external thread of the mating piece, are discussed in U.S. Pat. No. 2,870,668.

For securing screw connections, GB 2 086 516 A and DE 904 013 B disclose screws which each have a recess along their external thread.

It turns out that, owing to manufacturing tolerances, a loss in clamping torque may occur between a first tightening of the nut and the subsequent first loosening of the nut.

The problem which the invention proposes to solve is therefore to propose a nut which is improved over the prior art.

The invention solves the problem in that the internal thread of the nut comprises at least a first portion and a second portion, wherein the first portion has a first thread pitch which is constant over the first portion, wherein the first portion emerges at a lower end face situated opposite the upper end face of the nut body, and wherein the second portion has a second thread pitch which is constant over the second portion and which is smaller than the first thread pitch.

The first thread pitch of the first portion of the nut according to the invention is preferably adapted to the pitch of the mating piece, i.e., the bolt, for example, on which the nut is to be placed. The first thread pitch of the first portion may therefore also be called the regulating pitch of the nut. Hence, this is so to speak the nominal pitch of the nut, pertaining to the particular bolt or the application for the nut. Preferably, the first portion and the second portion border directly on each other. Overall, the internal thread of the nut is formed by an internal thread of the nut body and by an internal thread of the clamping segments.

Thus, the nut according to the invention does not have only a single thread pitch which is constant over the entire internal thread. This is based on the knowledge that, with a constant thread pitch—as in the prior art—a direct contact between the joining partners of the nut and a bolt, for example, will occur only via the first and the last thread turn of the internal thread of the nut. But as a rule these contact surfaces are too small to be able to transmit the usual prestressing forces without plastic deformation. However, a plastic deformation reduces the clamping in the clamping segment. The nut according to the invention preserves the clamping forces in the clamping region as much as possible and thus substantially regardless of the tightening torque applied or the resulting prestressing force.

The first portion ends at a lower end face of the nut body, and thus of the nut, situated opposite the upper end face of the nut body. During the fastening process, the nut is at first placed on the mating piece, such as a bolt, preferably with the lower end face—i.e., with the nut body. Thus, during the fastening process, at first the portion with the internal thread preferably adapted to the mating piece—i.e. with the first thread pitch—is screwed on, and only then is the second portion screwed on.

One embodiment proposes that the clamping segments taper—in particular conically. The clamping segments are thus inclined in this embodiment in the direction of the longitudinal axis of the nut. This occurs in one embodiment especially in the form of a cone.

One embodiment consists in that a height of the second portion along the longitudinal axis is substantially equal to a height of the clamping segments along the longitudinal axis. In addition, in one embodiment, it is proposed that the internal thread of the nut consists only of the first portion and the second portion. Therefore, in this embodiment, the internal thread has only the first thread pitch and the second thread pitch. Here, in one embodiment, the second portion ends with the free end face of the clamping segments and thus also with the upper end face of the nut. Preferably, in this case the first portion ends at the upper end face of the nut body

One embodiment consists in that the internal thread of the nut comprises a third portion. Preferably, the first portion, the second portion and the third portion follow each other in succession. The third portion has a third thread pitch, which is constant within the third portion—an alternative description is: over the third portion.

One embodiment proposes that a thread pitch of the third portion is substantially equal to the first thread pitch of the first portion. In this embodiment, there are thus three portions, of which two portions (namely, the first and the third portion) have the same thread pitch. Between the two portions is found a further portion (namely, the second portion), which has a smaller thread pitch. One embodiment proposes that the internal thread of the nut consists only of the first portion, the second portion and the third portion. Thus, the internal thread of the nut has only three portions, of which two portions (namely, the first and the third portion) have the same thread pitch, and a further portion—axially enclosed between the other two portions—(namely, the second portion) has a smaller pitch.

In one embodiment, the third portion ends with an upper end of the nut. In this embodiment, the first portion ends with the lower end face of the nut body and thus with the lower end of the nut and the third portion ends with the upper end of the nut and thus also with the free end of the clamping segments. Thus, the nut has the same thread pitch overall on an upper end face and on a lower end face. The second portion is situated in between.

One embodiment consists in that a height of the third portion along the longitudinal axis is substantially equal to a height of the clamping segments along the longitudinal axis. Alternatively, it is proposed that a height of the third portion along the longitudinal axis is larger than a height of the clamping segments along the longitudinal axis. Alternatively, it is proposed that a height of the third portion along the longitudinal axis is smaller than a height of the clamping segments along the longitudinal axis. In one embodiment it is provided in particular that the third portion ends with the free end face of the clamping segments. Depending on the embodiment, therefore, the third portion comprises the clamping segments, it comprises only an axial part of the clamping segments, or it extends even into the nut body.

One embodiment proposes that the second portion comprises at least one thread turn. In this embodiment, the axial height of the second portion is such that at least one preferably complete thread turn results.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 a three-dimensional representation of a nut,

FIG. 2 a cross section through a nut of the prior art,

FIG. 3 a cross section through a first variant of the nut according to the invention,

FIG. 4 a cross section through a nut not according to the invention and

FIG. 5 a cross section through a second variant of the nut according to the invention.

### DETAILED DESCRIPTION OF THE DRAWINGS

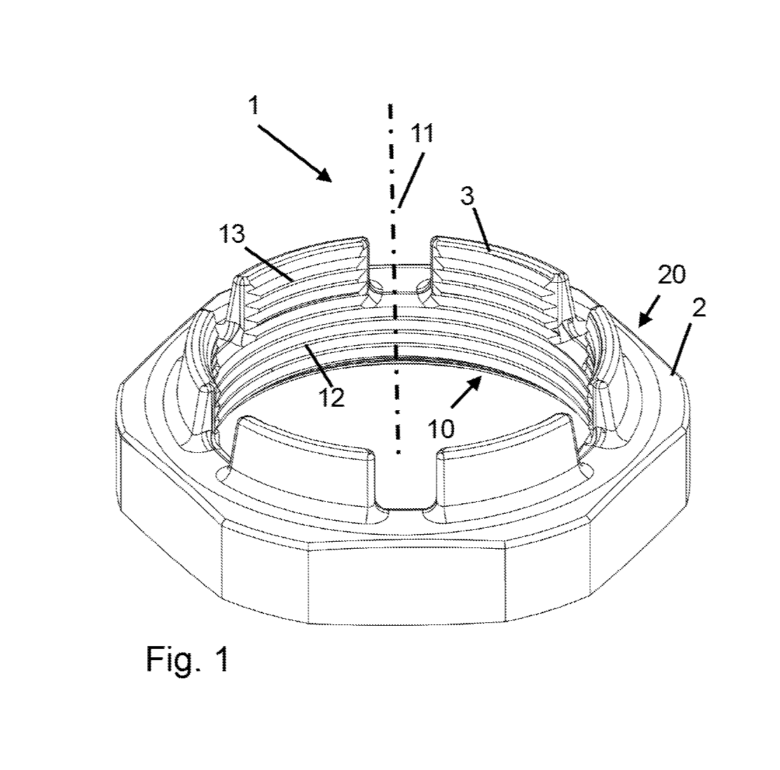

FIG. 1 shows a basic design of a nut 1, consisting of a nut body 2 and clamping segments 3. The nut body 2 in the embodiment shown has a polygonal outside, forming the operative surfaces for tools during the mounting and dismounting of the nut 1. The nut 1 for example is screwed onto or off from a bolt with an external thread—not shown here.

The clamping segments 3 emerge from the upper end face 20 of the nut body 2. The clamping segments 3 (alternatively known as clamping tongues) taper conically in the depicted embodiment in the direction of the longitudinal axis 11. The clamping segments 3 create by their free end, situated opposite the upper end face 20 of the nut body 2, the upper end of the nut 1.

The nut body 2 and the clamping segments 3 together create an internal thread 10 of the nut 1, which is composed of the internal thread 12 of the nut body 2 and the internal thread 13 of the clamping segments 3. In the embodiment shown, in particular a completely continuous internal thread 10 of the nut 1 is produced along the longitudinal axis 11.

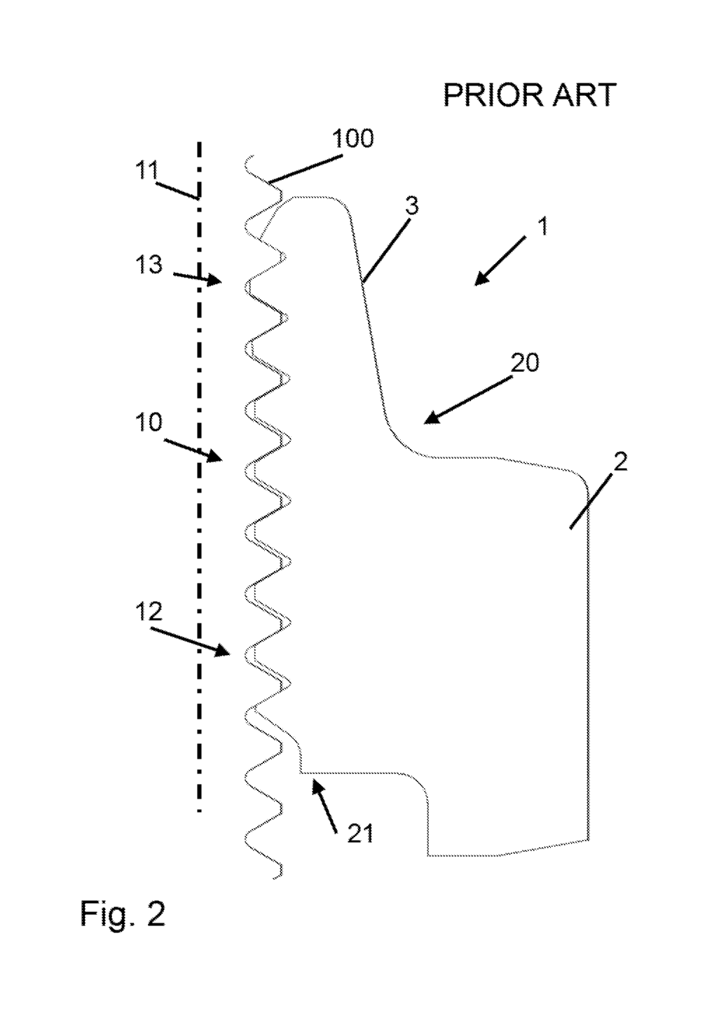

FIG. 2 shows a cross section through a nut 1 of the prior art, which has been mounted on a bolt 100. The nut 1 possesses the nut body 2 and the clamping segments 3, which emerge from the upper end face 20 of the nut body 2 and are conically tapering in the direction of the free end. Opposite the upper end face 20 of the nut body 2 is a lower end face 21, which thus also forms an end face of the nut 1. The upper, free end of the clamping segments 3 is another end face of the nut 1. Between the two end faces of the nut 1 is found an internal thread 10, which is formed by the internal thread 12 of the nut body 2 and the internal thread 13 of the clamping segments 3.

The internal thread 10 of the nut 1 extends along the longitudinal axis 11 and has a constant pitch. Furthermore, a pitch error is present. The thread pitch of the internal thread 10 therefore does not correspond to the thread pitch of the external thread of the bolt 100.

In the following figures, embodiments shall be described in which the internal thread 10 of the nut 1 according to the invention consists either of three portions or of two portions. Each time the drawings show the nut 1 and a bolt 100.

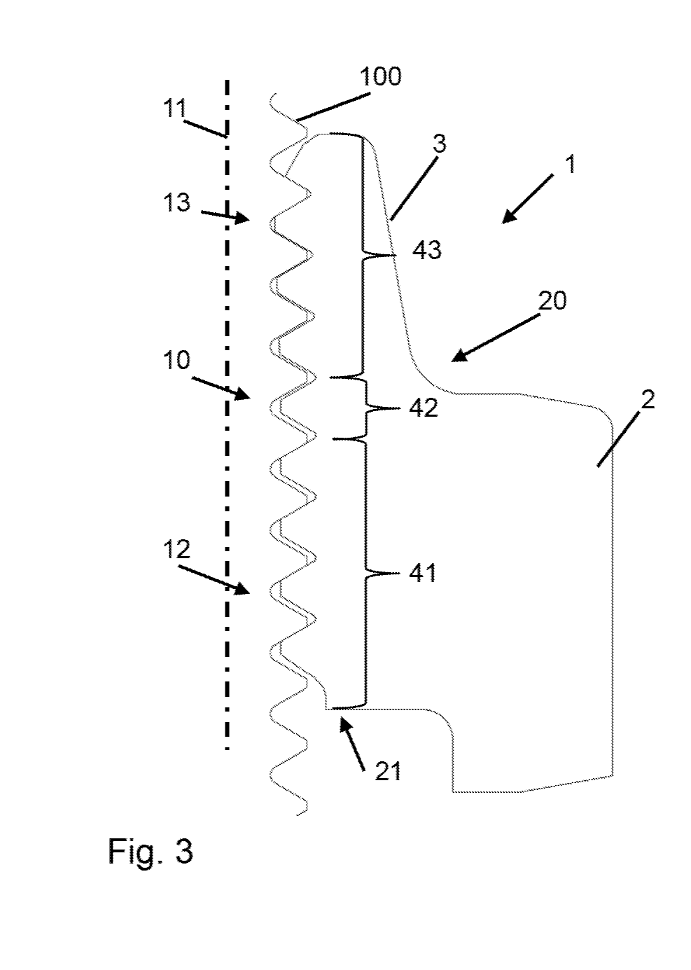

The nut 1 of the embodiment in FIG. 3 has an internal thread 10, produced by a total of three portions: a first portion 41, which ends at a lower end face 21 of the nut body 2, a third portion 43, which ends at the upper and thus free end of the clamping segments 3, and a second portion 42, which borders on the first portion 41 and the third portion 43 respectively and is enclosed by the two portions 41, 43.

The third portion 43 comprises in the embodiment shown the internal thread 13 of the clamping segment 3, so that the internal thread 12 of the nut body 2 is formed by the first portion 41 and the second portion 42.

The first portion 41 and the third portion 43 have the same thread pitch, which is equal to the standard pitch of the nut 1. This standard pitch of the nut 1 is the pitch of the bolt 100.

The second portion 42 has a second thread pitch, which is smaller than the first thread pitch of the first portion 41 as well as the third portion 43. The pitch of the second portion 42 is thus smaller than the pitch of the external thread of the bolt 100 on which the nut 1 is being placed. The height of the second portion 42 along the longitudinal axis 11 corresponds here to one thread turn.

The second pitch of the second portion 42 in one embodiment is preferably chosen such that the nut 1 oriented in the uppermost thread turn of the third portion 43 makes possible a minimal air gap in the first portion 41. This ensures that in event of overscrewing, only the clamping region has contact with the bolt 100. When secured with the desired prestressing force, the internal thread 10 of the nut 1 is set minimally until all screw turns are engaging in the region of the nut body 2. This ensures a lower loss of clamping torque, and one less influenced by the tightening torque, between the first securing and the first loosening of the nut 1 from the connection with the bolt 100.

The thread pitches within the three portions 41, 42, 43 are each constant.

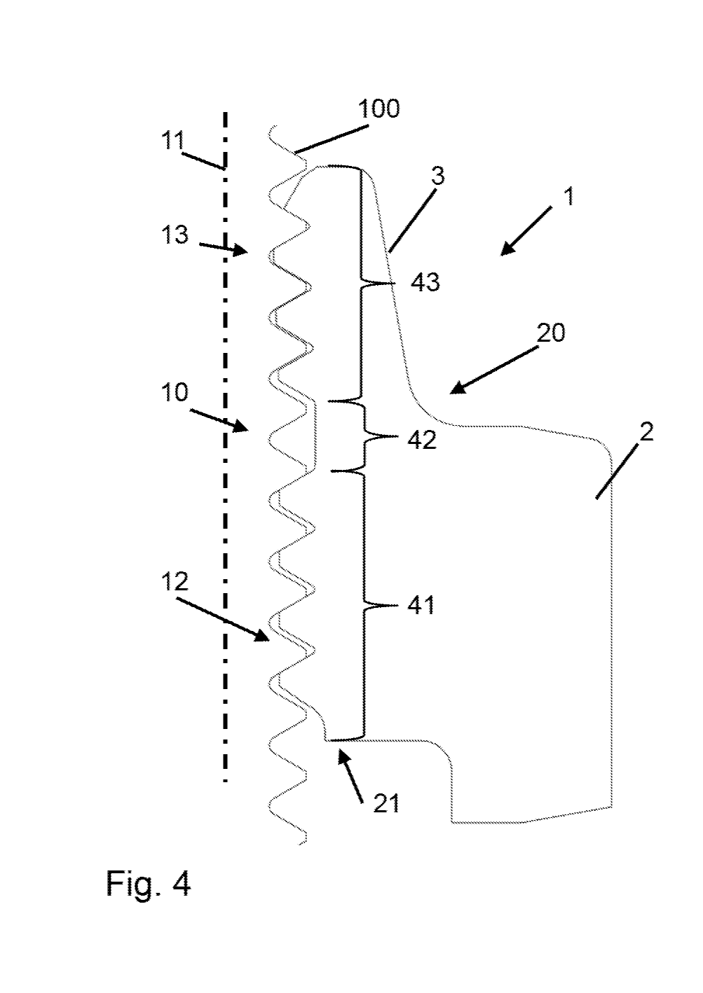

The nut 1 of the embodiment of FIG. 4 differs from the embodiment of FIG. 3 in the kind of the second portion 42. The nut 1 of FIG. 4 has a threadless second portion 42, which in this embodiment is realized by a recess. Thus, the internal thread 10 of the nut 1 is interrupted by the second portion 42. In the uppermost thread turn of the third portion 43, the nut 1 is axially oriented in the external thread of the bolt 100, since a maximum clamping occurs here. In addition, in the upper thread turns of the third portion 43 the securing clamping torque is created by the surface normal force and the coefficient of friction.

Investigations have shown that in a nut according to the prior art with an internal thread of constant thread pitch, a contact between the nut and a bolt may sometimes exist only at the thread turns of the lower end face of the nut body as well as at the upper, free end of the clamping segments. By contrast, the three portions 41, 42, 43 of the nut 1 of the embodiments of FIG. 3 bring about a distribution of the forces occurring by the prestressing force over the massive nut body 2, so that contact also exists there accordingly with the bolt 100. In particular, it has been found that the contact occurs primarily in the first portion 41 and at the free end of the clamping segments 3—i.e., in the third portion 43.

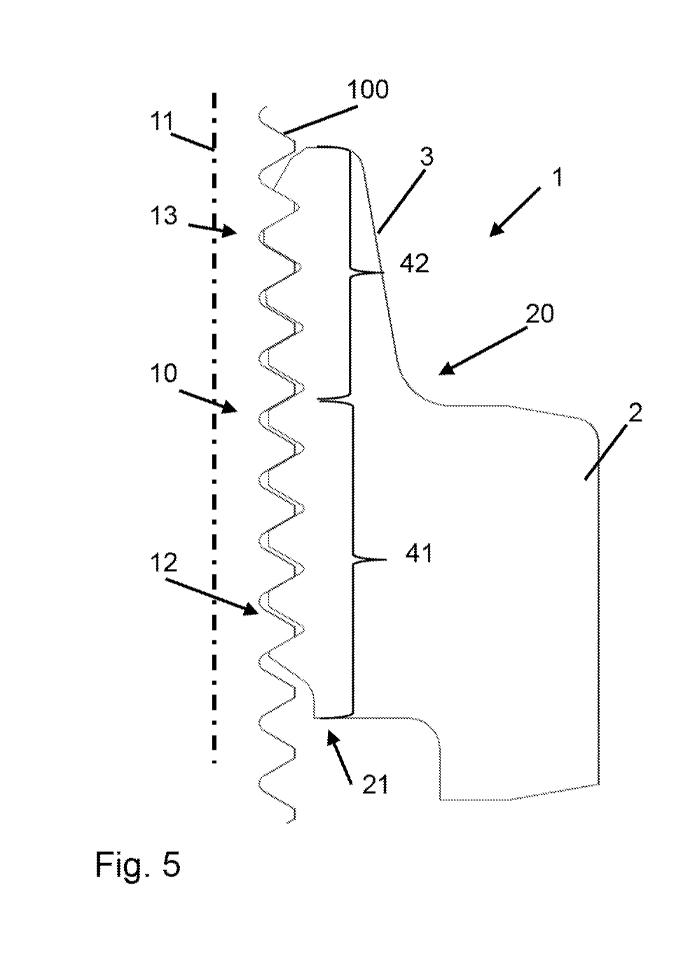

The nut 1 of FIG. 5 has an internal thread 10 which is formed by the internal thread 13 of the clamping segments 3 and the internal thread 12 of the nut body 2 and which is composed only of the first portion 41 and the second portion 42.

The first portion 41 in the embodiment shown comprises the internal thread 12 of the nut body 2 and the second portion 42 comprises the internal thread 13 of the clamping segments 3. Thus, the first portion 41 and hence the internal thread 12 of the nut body 2 has the first thread pitch. Bordering on this, the second portion 42, which is already resting more strongly against the bolt 100 on account of the conical tapering, has the lesser second thread pitch.

The first thread pitch and the second thread pitch here are each constant, so that the internal thread in the first portion 41 and in the second portion 42 each time have only one pitch. The first thread pitch of the first portion 41 is preferably the standard pitch of the nut 1 and thus equal to the thread pitch of the bolt 100 on which the nut 1 is being fastened.

Here as well, in one embodiment the pitch is reduced in the second portion 42 such that the nut 1, oriented in the uppermost thread turn of the second portion 42, makes possible a minimal air gap between the internal thread and the bolt 100.

Investigations have shown that, in the embodiment with two portions 41, 42 and thus two different in each case constant thread pitches in the portions, the contact between the bolt 100 occurs over the entire internal thread 10 of the nut 1. Thus, the forces occurring due to the prestressing force are also distributed over the entire internal thread 10 of the nut 1.

The nut 1 according to the invention accomplishes a reduction of the clamping torque, so that the first overscrewing torque can be reduced during the first tightening of the nut 1 on the bolt 100.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A nut, comprising:
a nut body;
a plurality of clamping segments emerging from an upper end face of the nut body; and
an internal thread extending along a longitudinal axis of the nut,
wherein
the internal thread of the nut includes at least a first portion and a second portion,
the first portion has a first thread pitch which is constant over the first portion,
the first portion ends at a lower end face situated opposite the upper end face of the nut body, and
the second portion has a second thread pitch which is constant over the second portion which is smaller than the first thread pitch.

2. The nut as claimed in claim 1, wherein
a height of the second portion along the longitudinal axis is equal to a height of the clamping segments along the longitudinal axis, and
the internal thread of the nut consists only of the first portion and the second portion.

3. The nut as claimed in claim 1, wherein
the internal thread of the nut consists only of the first portion (41), the second portion and a third portion, and
a thread pitch of the third portion is constant over the third portion and equal to the first thread pitch of the first portion.

4. The nut as claimed in claim 1, wherein
the clamping segments taper along the longitudinal axis.

5. The nut as claimed in claim 2, wherein
the clamping segments taper along the longitudinal axis.

6. The nut as claimed in claim 3, wherein
the clamping segments taper along the longitudinal axis.

7. The nut as claimed in claim 4, wherein
the clamping segments taper conically.

8. The nut as claimed in claim 5, wherein
the clamping segments taper conically.

9. The nut as claimed in claim 6, wherein
the clamping segments taper conically.

10. The nut as claimed in claim 1, wherein
the second portion includes at least one thread turn.

11. The nut as claimed in claim 2, wherein
the second portion includes at least one thread turn.

12. The nut as claimed in claim 3, wherein
the second portion includes at least one thread turn.

13. The nut as claimed in claim 4, wherein
the second portion includes at least one thread turn.

14. The nut as claimed in claim 5, wherein
the second portion includes at least one thread turn.

15. The nut as claimed in claim 6, wherein
the second portion includes at least one thread turn.

16. The nut as claimed in claim 7, wherein
the second portion includes at least one thread turn.

17. The nut as claimed in claim 8, wherein
the second portion includes at least one thread turn.

18. The nut as claimed in claim 9, wherein
the second portion includes at least one thread turn.
